(19) United States
(12) Patent Application Publication
(10) Pub. No.: US 2016/0162870 A1
(43) Pub. Date: Jun. 9, 2016

(54) SYSTEM AND METHOD OF IDENTIFYING MOBILE DEVICES OF USERS INVOLVED IN PURCHASE TRANSACTIONS

(71) Applicant: CATALINA MARKETING CORPORATION, St. Petersburg, FL (US)

(72) Inventors: JOSEPH HENSON, RIVER FOREST, IL (US); KEVIN KOTOWSKI, CHICAGO, IL (US)

(73) Assignee: CATALINA MARKETING CORPORATION, ST. PETERSBURG, FL (US)

(21) Appl. No.: 14/560,703

(22) Filed: Dec. 4, 2014

(51) Int. Cl. G06Q 20/32; G06Q 30/02; G06Q 20/40

(52) U.S. Cl. CPC G06Q 20/3224; G06Q 20/4016; G06Q 30/0255; G06Q 30/0261

(57) ABSTRACT

The disclosure relates to systems and methods of identifying mobile devices of users involved in purchase transactions. The system may obtain purchase information that indicates purchases made by users and location information associated with mobile devices that may be potentially associated with the users. The system may identify a mobile device of a user that makes a purchase at a retail establishment by comparing the time of the purchase, as determined from the purchase information, with timestamps of mobile device locations, which may indicate a time that the mobile device was at a given location. In this manner, even if the mobile device of the user is not known in connection with a given purchase transaction, the system may determine a probability that the mobile device belongs to the user based on the time of the purchase transaction and the timestamps of mobile device locations.

### FIELD OF THE INVENTION

The invention relates to systems and methods of identifying mobile devices of users involved in purchase transactions.

### BACKGROUND OF THE INVENTION

Retailers, advertisers, and others attempt to identify meaningful, relevant content to provide to consumers. For example, retailers may wish to provide promotions for items that are of interest to users in order to provide appropriate incentives, as well as to ensure that the users do not perceive that they are being inundated with promotional information that relate to items for which they have no interest. To that end, purchase history information is valuable because it can be used to identify items that users purchased (and therefore are of interest to the users) related items that are considered competing or complementing items to those items that have been purchased, and/or other items that may be of interest to users. For example, retailers can use loyalty programs to identify their customers and the purchases that they make. However, using only purchase history information to determine user interests can be incomplete. Other information, such as whether and what type of mobile devices that users may use and the locations that the users have visited, can be helpful to obtain a deeper understanding of user behavior, and therefore user interests. Typically, purchase histories do not include such information. Thus, a retailer may not know whether or what type of mobile device their customers use.

However, location-based information is being increasingly collected in various contexts, as the number of users who consent to the use of such information rises. Location services may share location information with friends and family, use location to track users for security purposes, and/or provide other location-based services. However, most location-based services are focused primarily on conveying information about a user's current location. As such, information regarding whether and what types of mobile devices are being used by customers is not effectively harnessed by retailers, advertisers, and/or other entities.

These and other problems exist.

### SUMMARY OF THE INVENTION

The invention addressing these and other drawbacks relates to systems and methods of identifying mobile devices of users involved in purchase transactions. According to an aspect of the invention, the system may obtain purchase information that indicates purchases made by users (e.g., a location of a purchase, user identifying information, items purchased, etc.), and location information associated with mobile devices that may potentially be associated with the users. Location information may be obtained directly from a mobile device, or from a location service that obtains the location information from the mobile device. In either instance, the location information may be obtained based on consent from the user of the mobile device.

The system may identify a mobile device of a user that makes a purchase at a retail establishment by comparing the time of the purchase (as determined from the obtained purchase information) with timestamps of mobile device locations. The timestamps may individually indicate a time that the mobile device was present at a given location (e.g., a location associated with a retail establishment), as determined from the location information. In this manner, even if the mobile device of the user is not known in connection with a given purchase transaction, the system may determine a probability that the mobile device belongs to the user based on the time of the purchase transaction and the timestamps of mobile device locations.

In an implementation, the system may identify more than one mobile device of a user. For example, an individual user may own/operate multiple mobile devices, one or more of which may be at a location in which the user is involved in a purchase transaction. Alternatively or additionally, an individual user may obtain a new mobile device to replace a previous mobile device. In either or both instances, the system may identify multiple mobile devices of an individual user. The system may do so by determining that, for example, two (or more) mobile devices are consistently located at locations where an individual user makes a purchase transaction. Based on such a determination, the system may identify two or more mobile devices that likely belong to the individual user.

In an implementation, the user identifying information may identify a household of more than one user that each use the same user identifying information for purchases (hereinafter, “household implementations” for convenience, although the users in a “household” could, but need not be family members nor share the same residence, but rather merely share the same user identifying information). For instance, a household of multiple individual users (e.g., family, friends, etc.) may be associated with a single loyalty account, a single credit card account, and/or other user identifying information. In this implementation, the system may identify different mobile devices (e.g., one for each individual user in a household) associated with the user identifying information. Alternatively or additionally, an individual user or group of users may be associated with more than one user identifying information (e.g., an individual user may use multiple credit cards, loyalty cards, etc.). The system may monitor purchase transactions for each user identifying information, as described herein.

In an implementation, the system may identify individual mobile devices for each member of a household. For example, for a set of purchases made using a single user identifying information, the system may associate each purchase with an individual mobile device that was present during the purchase. In this manner, the purchases of each member of the household may be identified using the presence (or absence) of a mobile device belonging to members of the household. In other words, in household implementations, household purchases made by multiple users each using a single user identifying information may be grouped based on individual mobile devices that were present during such purchases, which may serve as a proxy for identifying individual members of a household who made the purchases. Of course, one or more members of a household may be associated with multiple mobile devices. In the foregoing instance, the system may determine that a member of the household uses two or more mobile devices based on a similarly or purchase or other behavioral patterns (as described herein) monitored by the system for each of the mobile devices.

In an implementation, the system may identify two or more devices that are consistently located at location where household purchases are made. In some of these implementations, the system may determine that two or more members of the household are present together during the purchases. Such information may be used to target promotions for the two or more members. For example, the system may identify purchase or other patterns of behavior when the two or more members are together. Of course, the presence of two or more mobile devices may also indicate that an individual carries those two mobile devices. The system may disambiguate these scenarios as described herein.

Because several mobile devices may be located at or near a retail establishment when a given purchase transaction occurs, a probability that a given mobile device (or multiple mobile devices) belongs to a user based on a single purchase transaction may be relatively low. The system may improve the probability with additional observations of purchase transactions involving the user and timestamp(s) of mobile device locations.

For example, different purchases made by a given user at one or more retail establishments, at different times, may be associated with various mobile devices that were present at the locations when the purchases were made. If a given mobile device is determined to be at each of the locations where the given user's purchase transactions occurred, and during the times that such purchase transactions occurred, then the probability that the given mobile device belongs to the given user may be relatively high. On the other hand, if another mobile device is determined to be at only one of the locations where a given user's purchase transactions occurred, then the probability that the other mobile device belongs to a given user may be relatively low. As such, the system may use a plurality of purchase transactions of the given user to update the probability that a given mobile device belongs to the user (as well as update the probabilities that other mobile devices belong to the user).

In an implementation, when a probability that a given mobile device belongs to a given user exceeds a threshold value, the system may determine that the given mobile device belongs to the given user.

The identification of the user's mobile device may be used in various ways by the system (and others). For example, the system may use the user's mobile device as a communication channel through which to provide promotions (assuming, for example, that the user consents to receiving such communications via the mobile device).

In an implementation, the system may use the identification of the consumer's mobile device to determine in-store behavioral patterns associated with the purchase transaction. For example, using timestamps associated with the mobile device locations, the system may approximate a length of time that the user's mobile device was at a retail establishment when the purchase transaction was made. Thus, using this information, the system may determine an approximate shopping trip length for the given purchase transaction. Such in-store behavior may be used to target promotions to the user.

In an implementation, the system may use the identification of the user's mobile device to leverage the user purchase information and mobile device location information to determine behavioral patterns before and/or after the purchase transactions. For example, the system may determine locations that the user visited before (e.g., before arriving at a retail location where the purchase transaction occurred) and/or after (e.g., after leaving the retail location) the purchase transaction to determine out-of-store patterns of behavior. If such out-of-store patterns of behavior is determined, the system may target the user with promotions that may be relevant for the user based on the out-of-store behavioral patterns and/or the purchase information for the purchase transaction.

The promotions and other communications identified based on the purchase transaction, behavioral patterns, and/or other information may be delivered to the user in various ways. For example, the system may deliver the determined promotions and other communications to the user's mobile device, an in-store device (e.g., when the user is determined to be at a retail establishment that includes the in-store device), and/or via another communication channel.

In household implementations, the system may customize the promotions for based on household purchases. The customized promotions may be targeted for each individual member of the household based on his/her individual purchase information, targeted for more than one member, and/or targeted for all members of the household. For example, the system may identify a first mobile device of a first member of a household and identify a second mobile device of a second member of the household. The system may determine that the first member falls within a first demographic (e.g., is a male) and that the second member falls within a second demographic (e.g., is a female) based on their respective purchases. The system may determine a first set of promotions for the first member and a second set of promotions for the second member. The system may then provide the first set of promotions to the first mobile device of the first user and the second set of promotions for the second mobile device of the second user. Thus, even though the first user and the second user may use the same user identifying information for purchase transactions, the system may analyze and provide relevant information for each based on their respective purchase transactions, as determined from the presence or absence of their respective mobile devices. Alternatively or additionally, the system may provide a targeted promotion for the household (or at least two members of the household) as a single unit and provide the targeted promotion to one or more of the mobile devices associated with the household.

Advertisers, retailers, and others may use the system to further understand their users' behavioral patterns and interests so that more relevant promotions and other communications may be delivered to their users. Furthermore, the advertisers, retailers, and others may use the system to unobtrusively identify mobile devices of their users, assuming that the users have consented to the use of location information related to their mobile devices. Identifications of users' mobile devices may be used to classify users based on their mobile devices, provide promotions (and other relevant information) to the users via their mobile devices, and/or other purposes. Retail stores (e.g., convenience stores) that do not have the infrastructure to employ sophisticated marketing and location-based services may use the system to identify mobile devices of their customers and provide more relevant promotions. Other uses of the system will be apparent to those having skill in the art.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system of identifying mobile devices of users involved in purchase transactions, according to an implementation of the invention.

FIG. 2 illustrates non-limiting examples of purchase information, according to an implementation.

FIG. 3 illustrates non-limiting examples of location information, according to an implementation.

FIG. 4 illustrates non-limiting examples of associations between a given user and one or more user devices potentially belonging to the user, according to an implementation.

FIG. 5 illustrates areas associated with a retail establishment where transactions involving a particular user occurred and the presence of various user devices in the areas, according to an implementation.

FIG. 6 illustrates a flow diagram of a process of identifying mobile devices of users involved in purchase transactions, according to an implementation of the invention.

FIG. 7 illustrates a flow diagram of a process of iteratively updating a probability that a mobile device is associated with a user, according to an implementation of the invention.

### DETAILED DESCRIPTION OF THE INVENTION

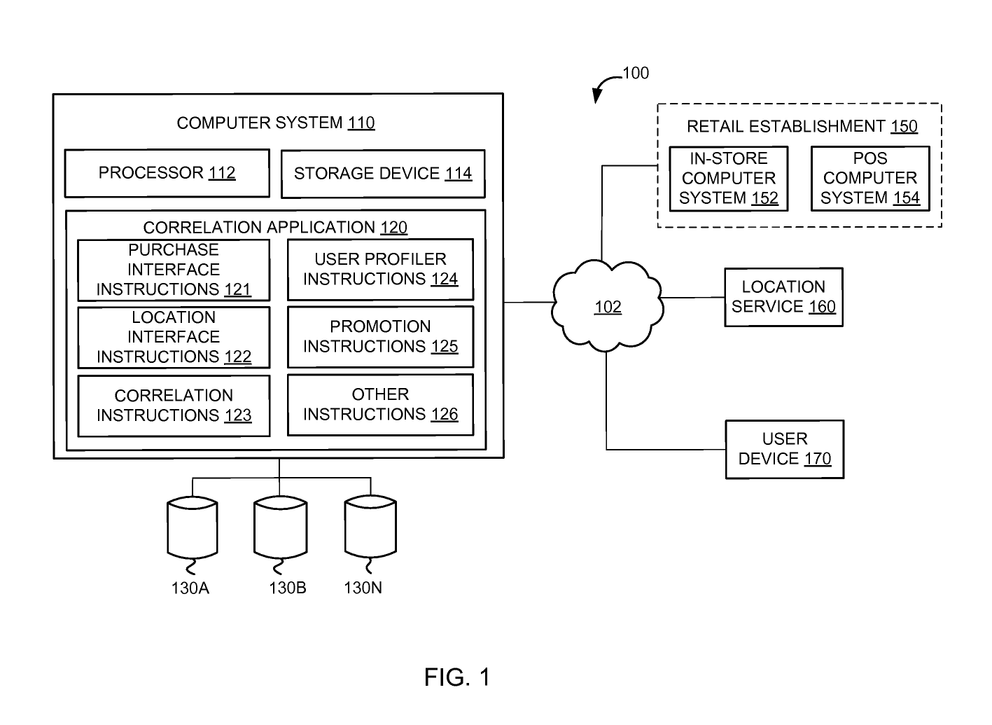

FIG. 1 is an exemplary depiction of a system 100 for identifying mobile devices of users involved in purchase transactions, according to an implementation of the invention. System 100 may obtain purchase information that indicates purchases made by users and location information associated with mobile device(s) 170 (hereinafter, mobile device 170 for convenience). The location information may be obtained directly from mobile device 170 or from a location service 160 that obtains the location information from mobile device 170. The location information may be obtained based on consent from the user of mobile device 170 to use such location information.

System 100 may identify mobile device 170 of a user that makes a purchase at a retail establishment by comparing the time of the purchase from the purchase information with timestamps of mobile device locations from the location information, which may indicate a time that mobile device 170 was at a given location. In this manner, even if the mobile device of the user is not known in connection with a given purchase transaction, system 100 may determine a probability that mobile device 170 belongs to the user based on the time of the purchase transaction and the timestamps of mobile device locations.

The identification of the user's mobile device may be used in various ways by the system and others. For example, system 100 may use the user's mobile device as a communication channel through which the system may provide promotions (assuming, for example, that the user consents to such communications).

In an implementation, system 100 may use the identification of the consumer's mobile device to determine in-store behavioral patterns associated with the purchase transaction. For example, using the timestamps associated with the mobile device locations, the system may approximate a length of time that the user's mobile device was at a retail establishment when the purchase transaction was made. Thus, using this information, the system may determine an approximate shopping trip length for the given purchase transaction. Such in-store behavior may be used to target promotions to the user.

In-store behavioral patterns may indicate in-store patterns of activity, which occur while the user is present at a given store. For example, in-store patterns of activity may include, for example, a length of time that the user is at a retail store before a purchase transaction occurs, a length of time that the user is at a retail store after the purchase transaction occurs, and/or other patterns of activity inside the store.

System 100 may monitor the location information associated with the user's mobile device to trigger certain promotions that may be determined to be relevant for a given location of the mobile device based not only on the given location but also on the behavioral patterns (e.g., in-store and/or out-of-store behavioral patterns) associated with the given location.

Out-of-store behavioral patterns may indicate patterns of locations that a user visits, including locations outside of a given store. For example, a given retail location may be associated with a particular behavioral pattern in which a particular user tends to visit, in order, a first location, a second location, and a retail location. Based on the particular behavioral pattern, the system may provide a promotion associated with the retail location when the particular user is expected engage in the particular behavioral pattern (e.g., if the particular user is determined to visit, in order, the first and second locations).

In an implementation, system 100 may use the identification of the user's mobile device to leverage the user purchase information and mobile device location information to determine behavioral patterns before and/or after the purchase transactions. For example, system 100 may determine locations that the user visited before and/or after the purchase transaction to determine out-of-store patterns of behavior. If such out-of-store patterns of behavior can be determined, system 100 may target the user with promotions that may be relevant for the user based on the out-of-store behavioral patterns.

Advertisers, retailers, and others may use system 100 to further understand their users' behavioral patterns and interests so that more relevant promotions and other communications may be delivered to their users. Furthermore, the advertisers, retailers, and others may use the system to unobtrusively identify mobile devices of their users, assuming that the users have consented to the use of location information related to their mobile devices.

Other uses of system 100 are described herein and still others will be apparent to those having skill in the art. Having described a high level overview of some of the system functions, attention will now be turned to various system components that facilitate these and other functions.

System 100 may include a computer system 110, one or more databases 130 (illustrated in FIG. 1 as databases 130A, 130B, . . . , 130N), an in-store computer system 152, a point of sale computer system 154, a location service 160, a mobile device 170, and/or other components.

Computer system 110 may include one or more processors 112 (also interchangeably referred to herein as processors 112 or processor 112 for convenience) programmed by computer program instructions comprising a correlation application 120. Correlation application 120 may include one or more sets of instructions that program the one or more processors 112. For example, correlation application 120 may include, without limitation, purchase interface instructions 121, location interface instructions 122, correlation instructions 123, user profiler instructions 124, promotion instructions 125, and/or other instructions 126.

Obtaining and Storing Purchase Information for Purchase Transactions

In an implementation, purchase interface instructions 121 may program the processors 112 (and therefore computer system 110) to interface with and obtain purchase information from in-store computer system 152, point of sale computer system 154, and/or other devices or systems that have access to the purchase information. As used hereinafter, for convenience, the various instructions will be described as performing an operation, when, in fact, the various instructions program the processors 112 to perform the operation.

The purchase information may include information related to one or more purchase transactions. For example, the purchase information may include, without limitation, a time (e.g., a date, and/or a time of day) when a given purchase transaction occurred, user identification information, retailer identification information that identifies retail establishment 150 at which the purchase transaction occurred, an item identification information, an item price, a unit price, an item quantity, a discount applied, an incentive redeemed, and/or other information related to a given purchase transaction.

The user identification information may be used to identify a user who was involved in the given purchase transaction. For example, the user identification information may include, without limitation, a loyalty account identification, a payment identification (e.g., credit card number, debit card number, etc.), a name, and/or other information used to identify the user. As would be appreciated, the user identification information may be appropriately de-identified such as through encryption, removal of portions of the identifying information, and/or other de-identification techniques. In an implementation, the user identification information may be used to identify more than one user. For example, more than one family member, friend, etc., may use the same loyalty card, payment card, and/or other identifying information for purchase transactions. In this implementation, multiple mobile devices (e.g., one for each family member) may be correlated with the user identification information.

The item identification information may be used to identify a given item (e.g., a product and/or service) that was purchased during a given purchase transaction. For example, the item identification information may include, without limitation, a Universal Product Code (“UPC”), a Quick Response (“QR”) code, and/or other information that can be used to identify the given item.

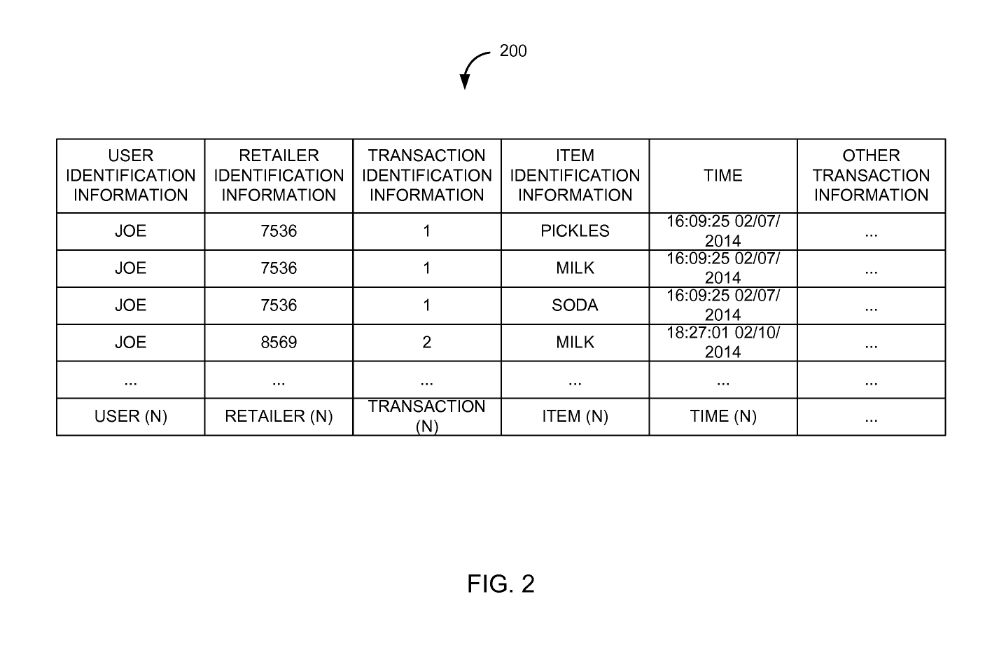

Referring to FIG. 2, non-limiting examples of purchase information 200 are illustrated. In example illustrated in FIG. 2, a user “JOE” was involved in two purchase transactions identified by the transaction identification information “1” and “2” and retail establishments identified by retailer identification information, “7536” and “8569.” The retailer identification information may be associated with a particular location that is defined by latitude/longitude coordinates, an address, and/or other location-indicating method. The retail establishments may belong to the same or different retail chain (or individual stores). The purchase information may include an identification of Items purchased during each of the purchase transactions, a time of the purchase transaction, and/or other transaction information. The time may include a time of day (e.g., “16:09:25”) and/or a date (e.g., “Feb. 7, 2014”).

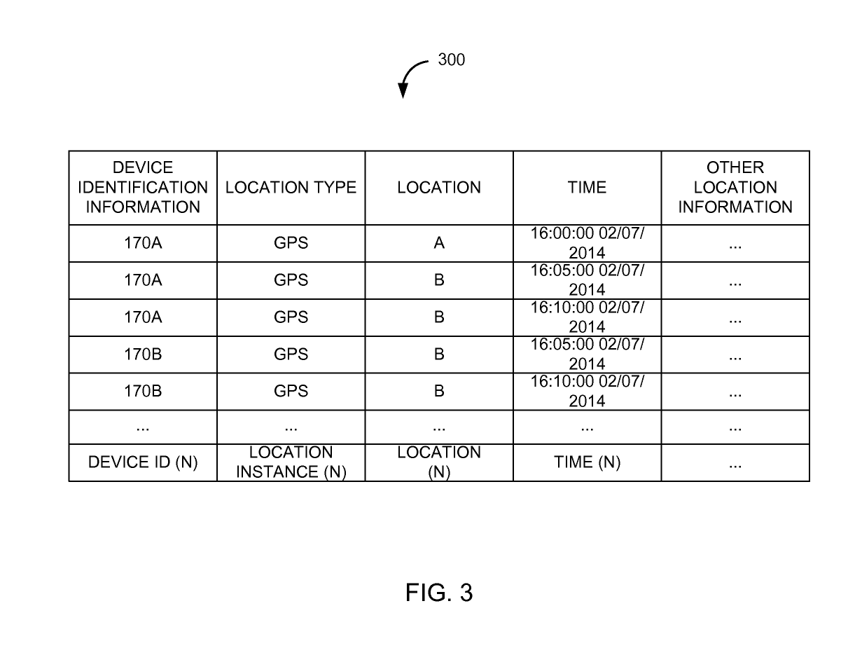

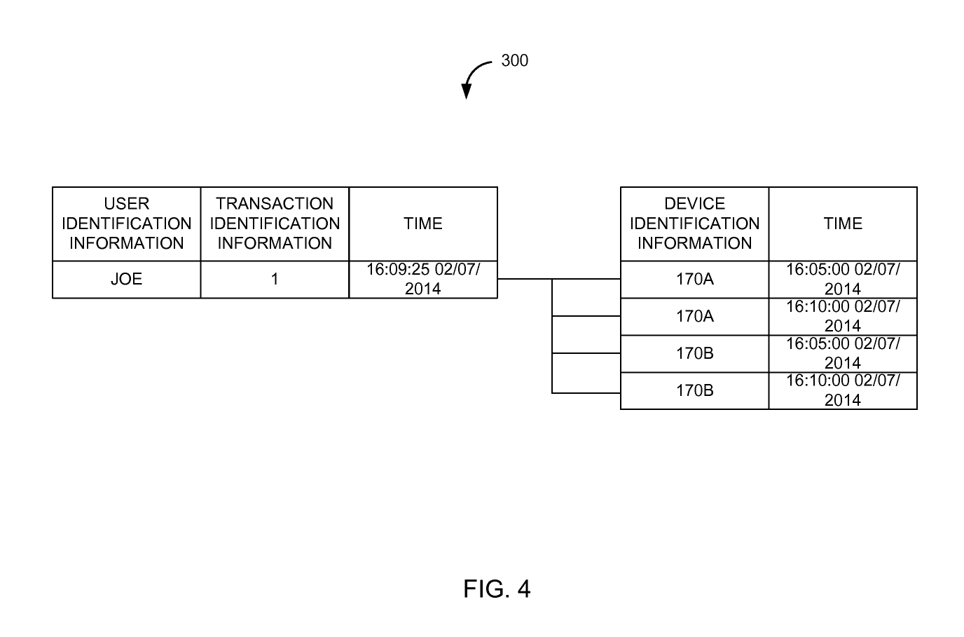

The purchase information may include other purchase transactions of user JOE and/or the purchase transactions of other users. Furthermore, the particular values and types of information illustrated in FIG. 2 and in other drawing figures (e.g., FIGS. 3 and 4) are for illustrative purposes only and are not intended to be limiting. Other values and types of information may be used as well. For example, instead of or in addition to using numeric retail identification information, retail establishments may be identified using common names of the retail establishment and/or address of the retail establishments. In an implementation, the retail identification information may be associated with a location in a database (e.g., one or more databases 130) so that computer system 110 may obtain the location of a given retail establishment.

The purchase information may be received in batches (e.g., as part of a data transmission that occurs hourly, nightly, etc.) and/or as each purchase transaction is being processed. Furthermore, the purchase information may be pulled by or pushed to computer system 110. Upon receipt, purchase interface instructions 121 may store the purchase information in one or more databases 130 to maintain purchase histories, which may be indexed by user identification information, time, and/or other piece of purchase information.

Obtaining and Storing Location Information of Mobile Devices

In an implementation, location interface instructions 122 may interface with and obtain location information from location service 160 and/or mobile device 170. The location information may include information related to a location of mobile device 170, a type of location assessment used, confidence information, mobile device identification information, device type information, a timestamp that indicates a time (e.g., date and/or time of day) that the mobile device was at the location, and/or other information related to a location of mobile device 170.

The location may be specified as a longitude/latitude coordinate, a geographical area, an address, a zip code, an area code, and/or other information that can specify a location. In an implementation, the location information may include a type of location assessment used to obtain the location. Different types of location assessments may include, without limitation, Global Positioning System (“GPS”), cell tower triangulation, WiFi (e.g., Institute of Electrical and Electronics Engineers 802.11 specification) hotspot identification, social media check-in information, manual user inputs, and/or other types of assessments that may be used to indicate a location of a given mobile device 170.

Different location assessments may be associated with different levels of accuracy. As such, the location information may include confidence information that indicates an accuracy of the location specified by the location information. The location information may include the confidence information to indicate such accuracy and/or the type of location assessment used to estimate the location so that the accuracy of the technique may be obtained. The confidence information and/or the type of location assessment used, if provided, may be used to adjust the probability that a given mobile device belongs to a given user, as discussed with respect to correlation instructions 123. The level of accuracy of each type of location assessment may be predefined and/or customizable by one or more user of computer system 110 (e.g., a system administrator, a retail entity, an advertising entity).

Mobile device identification information may include information used to identify mobile device 170, an account associated with mobile device 170, and/or other information that can be used to identify mobile device 170. Device type information may specify a make, a model, an operating system version, and/or other information that indicates a type of mobile device 170 that provides its location to location server 160 and/or location interface instructions 122.

The location information may be received in batches (e.g., as part of a data transmission that occurs hourly, nightly, etc.) and/or in real-time as location information is determined at location service 160 and/or mobile device 170. Furthermore, the location information may be pulled by or pushed to location interface instructions 122. Upon receipt, location interface instructions 122 may store the location information in one or more databases 130 to maintain location histories, which may be indexed according to mobile device identification information, time, and/or other information.

Referring to FIG. 3, non-limiting examples of location information 300 are illustrated, according to an implementation. In the example illustrated in FIG. 3, a user device 170A was at location “A” at time 16:00:00 on Feb. 7, 2014, and at location “B” at times 16:05:00 and 16:10:00 on Feb. 7, 2014. User device 170B was at location “B” at times 16:05:00 and 16:10:00 on Feb. 7, 2014. As illustrated in FIG. 3, each of the locations were derived using a GPS location assessment. Locations “A” and “B” may be specified using latitude/longitude coordinates, an address, a place name (e.g., name of a retail establishment), and/or other location indicia.

Comparing the Purchase Information and the Location Information to Identify Mobile Devices of Users Involved in the Purchase Transactions

In an implementation, correlation instructions 123 may compare purchase information and location information to identify mobile devices 170 that likely are associated with (e.g., are owned, carried by, and/or “belong to”) users who made purchases from one or more retail establishments 150, as determined from the purchase information.

In particular, correlation instructions 123 may compare a time that a given transaction occurred at a given retail establishment, as determined from the purchase information, with timestamps of mobile device locations. Based on the comparison, correlation instructions 123 may identify mobile devices 170 that were in an area of the given retail establishment 150 at the time that the given transaction occurred. For example, correlation instructions 123 may identify mobile devices 170 that were at the given retail establishment when a given user was involved in a given transaction.

Referring to FIG. 4, non-limiting examples of the associations 200 between a given user and possible user devices that belong to the user are illustrated, according to an implementation.

In an implementation, correlation instructions 123 may determine that a given mobile device 170 (individually illustrated in FIG. 4 as mobile device 170A, 170B, 170C, 170D, 170E, 170F, . . . , 170N) is at the given retail establishment 150 if the location of the mobile device is within a threshold area of the given retail establishment for a threshold duration of time. For example, correlation instructions 123 may determine that the given mobile device 170 is at the given retail establishment if the mobile device is within ten feet of retail establishment 150 for at least five minutes. Of course, other distance ranges and/or time intervals may be used as well.

To adjust for potential inaccuracies in the location information, the threshold area and the threshold duration of time may be predefined and/or customizable by one or more users of computer system 110. Such customizations may be stored in association with the retail establishment. In an implementation, the threshold area may differ depending on the confidence level (which may indicate an accuracy of the location assessment) of the location assessment in the location information. For example, for location assessments associated with lower confidence levels, correlation instructions 123 may increase the size of the threshold area to account for potentially less accurate location assessments. On the other hand, for location assessments associated with higher confidence levels, correlation instructions 123 may decrease the size of the threshold area to take advantage of the higher accuracy of the location assessment. In an implementation, the threshold areas and the threshold duration may be predefined and/or customized by one or more users of computer system 110 (as well as adjusted as described herein).

In an implementation, correlation instructions 123 may determine a probability that a given mobile device 170 is associated with a given user based on, without limitation, a number of other mobile devices 170 determined to be at the retail establishment 150 during a given transaction, the confidence of a corresponding location assessment, a length of time after a transaction that a given mobile device remains at the retail establishment, a number of comparisons of individual transaction data with location data, and/or other factors. As such, correlation instructions 123 may determine a probability score that indicates a likelihood that a given mobile device 170 is associated with the given user based on one or more of the foregoing factors.

In an implementation, correlation instructions 123 may determine (or update) the probability score based on a number of mobile devices 170 that were in the retail establishment 150 when a given transaction occurred. For example, correlation instructions 123 may determine a probability score for each of the mobile devices 170 based on the number (and/or one or more of the foregoing factors). For example, a greater number of mobile devices 170 may result in a relatively lower probability score for each of the mobile devices. On the other hand, a lower number of mobile devices 170 may result in a relatively higher probability score for each of the mobile devices. This is because a greater number of mobile devices 170 that were present at the retail establishment 150 may decrease the chance that any one of the mobile devices belong to the user who was involved in the purchase transaction and vice versa.

In an implementation, correlation instructions 123 may determine (or update) the probability score based on the confidence of the location assessment (if provided). For example, lower confidence may result in lower probability scores.

In an implementation, correlation instructions 123 may determine (or update) the probability score based on a length of time that a given mobile device remains at the retail establishment after a transaction has occurred. For example, if a given mobile device remains at the retail establishment after a purchase transaction has occurred for a length of time that exceeds a threshold time, correlation instructions 123 may decrease the probability score. This is because it is less likely that a user involved in the purchase transaction will remain in the retail establishment after the purchase transaction was completed. The threshold time may be predefined, customized by one or more users of computer system 110, and stored in a database (e.g., one or more databases 130) for later retrieval. The threshold time may be configured to account for lag times in location reporting, the time it may take a user to leave the retail establishment after the purchase transaction has completed, and/or other criteria.

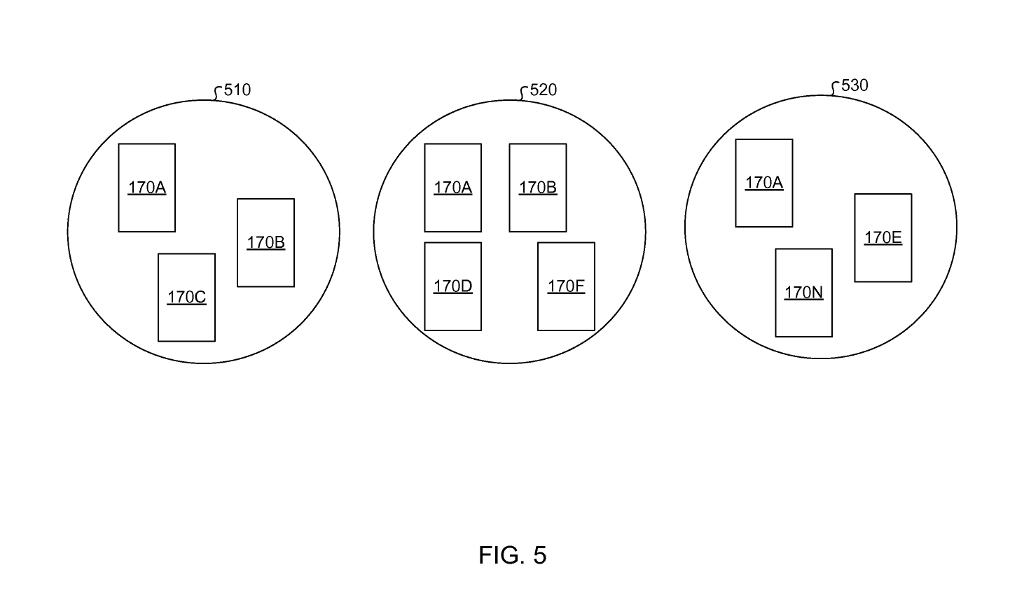

In an implementation, correlation instructions 123 may determine (or update) the probability score based on iterative comparisons between different transactions and different location information over time. For example, referring to FIG. 5, three areas 510, 520, and 530 associated with a retail establishment are schematically illustrated where transactions involving a particular user occurred. In other words, the particular user was involved in a first transaction in a retail establishment associated with area 510, a second transaction in a retail establishment associated with area 520, and a third transaction in a retail establishment associated with area 530. Areas 510, 520, and 530 may be associated with the same retail establishment or different retail establishments. As such, the three transactions occurring in areas 510, 520, and 530 referred to in FIG. 5 may occur at the same or different retail establishments.

As illustrated in FIG. 5, mobile devices 170A, 170B, and 170C were present in area 510 when the first transaction occurred. Thus, correlation instructions 123 may determine that mobile devices 170A, 170B, and 170C potentially belong to the particular user involved in the first transaction. Correlation instructions 123 may assign a probability that mobile device 170A belongs to the particular user, a probability that mobile device 170B belongs to the particular user, and a probability that mobile device 170C belongs to the particular user. The foregoing probabilities may be based on the various factors described herein.

Mobile devices 170A, 170B, 170D, and 170F were present in area 520 when the second transaction occurred. Thus, correlation instructions 123 may determine that mobile devices 170A, 170B, 170D, and 170F potentially belong to the particular user involved in the second transaction. Because mobile devices 170A and 170B were both also in area 510 during the first transaction, correlation instructions 123 may increase the probability that these two mobile devices belong to the particular user after the second transaction. On the other hand, because mobile device 170C is not present during the second transaction, correlation instructions 123 may decrease the probability that mobile device 170C belongs to the particular user after the second transaction.

Mobile devices 170A, 170E, and 170N were in area 530 when the third transaction occurred. Thus, correlation instructions 123 may determine that mobile devices 170A, 170E, and 170N potentially belong to the particular user involved in the third transaction. Because mobile device 170A was in area 510, 520, and 530 when the first, second, and third transactions occurred, correlation instructions 123 may further increase the probability that mobile device 170 belongs to the particular user involved in the first, second, and third transactions. On the other hand, because mobile device 170C was not in area 530, correlation instructions 123 may further decrease the probability that mobile device 170C belongs to the particular user after the third transaction. As additional transactions are observed, correlation instructions 123 may continue to update the probability that a given mobile device 170 belongs to a given user involved in a given transaction.

In an implementation, when the probability that a given mobile device is associated with a given user exceeds a threshold value, correlation instructions 123 may determine that the given mobile device is indeed associated with the user. As such, computer system 110 may add the given mobile device to a user profile associated with the user.

Profiling Users Based on the Identified Mobile Devices

In an implementation, user profiler instructions 124 may obtain and/or generate a user profile for a given user that is used to provide more relevant promotions and other information to the user. For example, an existing user profile that includes purchase histories, demographic information, and/or other information known about a user may be obtained from one or more databases 130. User profiler instructions 124 may update the user profile to include information indicating that the user is associated with mobile device 170, as determined by correlation instructions 123.

In another example, user profiler instructions 124 may create a new user profile that includes information indicating that the user is associated with mobile device 170. User profiler instructions 124 may update the user profile with purchase history information, demographic information, and/or other information known about the user.

Whether created and/or updated, user profiler instructions 124 may store the user profile in one or more databases 130.

The information indicating that the user is associated with mobile device 170 may include an affirmative determination that the user is associated with mobile device 170 (e.g., the corresponding probability exceeds the threshold value as described above) and/or a probability that the user is associated with mobile device 170.

In an implementation, information indicating that the user is associated with mobile device 170 may be used to segment the user into a class of users. For example, a user segment may include users that are “mobile savvy.” User profiler instructions 124 may segment the user into this user segment based on the user having a mobile device that can provide its location, which is obtained by correlation instructions 123 to determine that the mobile device is associated with the user. Users who belong to the mobile savvy segment may be provided with certain promotions that are not offered to users who are not in the mobile savvy segment.

In an implementation, user profiler instructions 124 may add the type of mobile device (if available) to the user profile. The type of mobile device may be used to determine relevant promotions. For example, accessories for certain devices may be relevant for some types of devices but not others. The type of mobile device associated with the user may therefore be used to determine, for example, promotions that may be relevant for the type of device associated with the user.

In another example, a class of users associated with a type of device may have different preferences than another class of users associated with another type of device. Such information may be used to further segment the users into classes and therefore potentially provide more relevant promotions to the users. For example, a first user having a first type of device may be associated with a first segment of users that also have the first type of device. The first segment of users may also share purchase behaviors and/or other behavioral patterns with one another. Likewise a second user having a second type of device may be associated with a second segment of users that also have the second type of device (and also share one or more behavioral patterns with one another).

In an implementation, user profiler instructions 124 may analyze locations visited prior to and/or after a purchase transaction to identify patterns of behavior based on the purchase information and the location information. For example, user profiler instructions 124 may determine a path traveled by the user, which may include one or more stops at one or more retail establishments to conduct a purchase transaction. User profiler instructions 124 may correlate purchases made during the purchase transaction with locations visited prior to and/or after the purchase transaction. Alternatively or additionally, user profiler instructions 124 may correlate locations visited with one another (e.g., a pattern of visited locations such as gas station, drug store, etc.). If a pattern is observed, user profile instructions 124 may include the pattern in the user profile.

Targeting Users with Promotions

In an implementation, promotion instructions 125 may identify relevant promotions such as incentives, rebates, coupons, and/or other information that may interest a given user based on a corresponding user profile, which may include information that the user is associated with mobile device 170. For example, promotion instructions 125 may provide relevant information for the user based on user segments, purchase histories, the information that the user is associated with mobile device 170, and/or other information from the corresponding user profile.

In an implementation, promotion instructions 125 may obtain real-time location information of a mobile device 170 associated with a user, identify the user associated with mobile device 170, identify relevant promotions, and deliver the relevant promotions to the user in real-time and/or at a later time. For example, based on a pattern of locations observed by user profiler instructions 124 and a current location of mobile device 170, promotion instructions 125 may predict a next location to be visited and provide a relevant promotion based on purchases made during a previous purchase transaction, as determined from the purchase information.

Correlating Multiple Mobile Devices with an Individual User Identification

In an implementation, correlation instructions 123 may identify more than one mobile device of a user. For example, an individual user may own/operate multiple mobile devices, one or more of which may be at a location in which the user is involved in a purchase transaction. Alternatively or additionally, an individual user may obtain a new mobile device to replace a previous mobile device. In either or both instances, the system may identify multiple mobile devices of an individual user. Correlation instructions 123 may do so by determining that, for example, two (or more) mobile devices are consistently located at locations where an individual user makes a purchase transaction. Based on such a determination, the system may identify two or more mobile devices that likely belong to the individual user.

In an implementation, the user identifying information may identify a household of more than one user that each use the same user identifying information for purchases (hereinafter, “household implementations” for convenience, although the users in a “household” could, but need not be family members nor share the same residence, but rather merely share the same user identifying information). For instance, a household of multiple individual users (e.g., family, friends, etc.) may be associated with a single loyalty account identification, a single credit card account identification, and/or other user identifying information. In this implementation, correlation instructions 123 may identify different mobile devices (e.g., one for each individual user in a household) associated with the user identifying information. Alternatively or additionally, an individual user or group of users may be associated with more than one user identifying information (e.g., an individual user may use multiple credit cards, loyalty cards, etc.). Correlation instructions 123 may monitor purchase transactions for each user identifying information, as described herein.

In an implementation, correlation instructions 123 may identify individual mobile devices for each member of a household. For example, for a set of purchases made using a single user identifying information, correlation instructions 123 may associate each purchase with an individual mobile device that was present during the purchase. In this manner, the purchases of each member of the household may be identified using the presence (or absence) of a mobile device belonging to members of the household. In other words, in household implementations, household purchases made by multiple users each using a single user identifying information may be grouped based on individual mobile devices that were present during such purchases, which may serve as a proxy for identifying individual members of a household who made the purchases. Of course, one or more members of a household may be associated with multiple mobile devices. In the foregoing instance, correlation instructions 123 may determine that a member of the household uses two or more mobile devices based on a similarly or purchase or other behavioral patterns (as described herein) monitored by the system for each of the mobile devices.

In an implementation, correlation instructions 123 may identify two or more devices that are consistently located at location where household purchases are made. In some of these implementations, the system may determine that two or more members of the household are present together during the purchases. Such information may be used to target promotions for the two or more members. For example, correlation instructions 123 may identify purchase or other patterns of behavior when the two or more members are together. Of course, the presence of two or more mobile devices may also indicate that an individual carries those two mobile devices. The system may determine which of these scenarios is likely as described with respect to Tables 1 and 2.

Table 1 (depicted below) illustrates a non-limiting example of four transactions, each associated with a single user identification, that are correlated to two different mobile devices. Table 1 is presented solely for illustrative purposes and should not be viewed as limiting. Any number of transactions, user identifications, and device identifications may be used. The correlations depicted in Table 1 may be made by correlation instructions 123 using various techniques described herein.

TABLE 1

| Transaction Identification | User Identification | Device Identification |
|---|---|---|
| Information | Information | Information |
| 1 | 1001 | 56 |
| 2 | 1001 | 56 |
| 3 | 1001 | 57 |
| 4 | 1001 | 57 |

As illustrated in Table 1, a single user identification (User Identification Information 1001 in Table 1, or User ID 1001 for convenience) is associated with multiple transactions identified by Transaction Identification Information 1, 2, 3, and 4 in Table 1 (transactions 1, 2, 3, and 4, for convenience). Transactions 1 and 2 may be correlated with a single mobile device identified by Device Identification Information 56 (device ID 56 for convenience). Transactions 3 and 4 may be associated with another mobile device identified by device ID 57.

The correlations in Table 1 may indicate one of at least two scenarios, in which: (1) a single user identified by User ID 1001 operates two mobile devices identified by device IDs 56 and 57 and was involved in transactions 1, 2, 3, and 4; or (2) at least two members of a household identified by User ID 1001 each operate a respective mobile device identified by device IDs 56 and 57.

To determine which one of the two (or other) scenarios is likely, the system may monitor transactions (other than transactions 1, 2, 3, and 4) in which device ID 56 and 57 are correlated. For instance, the system may determine that transactions correlated with device ID 56 are different in nature than transactions correlated with device ID 57. In a particular example, device ID 56 may be correlated with transactions that indicate purchases made by an individual of a first demographic and device ID 57 may be correlated with transactions that indicate purchases made by an individual of a second demographic. In these instances, the system may determine that two different users that are part of the same household are involved in the transactions. On the other hand, if the purchases associated with purchase transactions correlated with device IDs 56 and 57 are similar in nature to one another, then the system may determine that a single user operates or is associated with mobile devices identified by device IDs 56 and 57. Such information may provide insights on the makeup or structure of a household and/or individual purchase and other behaviors.

Table 2 (depicted below) illustrates a non-limiting example of four transactions, each associated with a single user identification, that are correlated to two different sets of mobile devices. Table 2 is presented solely for illustrative purposes and should not be viewed as limiting. Any number of transaction identifications, user identifications, and device identifications may be used. The correlations depicted in Table 2 may be made by correlation engine 123 using various techniques described herein.

TABLE 2

| Transaction Identification | User Identification | Device Identification |
|---|---|---|
| Information | Information | Information |
| 11 | 2001 | 50, 51 |
| 12 | 2001 | 50, 51 |
| 13 | 2001 | 50, 51 |
| 14 | 2001 | 50, 51 |

As illustrated in Table 2, a single user identification (User Identification Information 2001 in Table 2, or User ID 2001 for convenience) is associated with multiple transactions identified by Transaction Identification Information 11, 12, 13, and 14 in Table 2 (transactions 11, 12, 13, and 14, for convenience). Transactions 11, 12, 13, and 14 may each be correlated with two devices identified by Device Identification Information 50 and 51 (device ID 50 and 51 for convenience).

The correlations in Table 2 may indicate one of at least two scenarios, in which: (1) a single user identified by User ID 2001 operates two mobile devices identified by device ID 50 and 51, and was involved in and carried both devices during transactions 11, 12, 13, and 14; or (2) at least two members of a household identified by User ID 2001 each operate a respective mobile device identified by device ID 50 or 51 and are present with one another during transactions 11, 12, 13, and 14.

To determine which of one of the scenarios is likely, the system may monitor transactions (other than transactions 11, 12, 13, and 14) in which device ID 50 and 51 are correlated, in a manner similar to the monitoring discussed above in relation to Table 1. For instance, if transactions correlated with device IDs 50 and 51 are similar in nature to one another and/or if mobile devices identified by device IDs 50 and 51 are usually together during a given transaction, the system may determine that a single user carries both mobile devices during the transactions. On the other hand, if transactions correlated with device ID 50 (when a device identified by device ID 51 is not present) are different in nature than transactions correlated with device ID 51 (when a device identified by device ID 50 is not present), then the system may determine that devices identified by device IDs 50 and 51 may be carried by different users who are members of a household and that purchases in which both mobile devices are present indicate that both members are present during those purchases.

In household implementations, promotion instructions 125 may customize the promotions for based on household purchases. The customized promotions may be targeted for each individual member of the household based on his/her individual purchase information, targeted for more than one member, and/or targeted for all members of the household. For example, correlation instructions 123 may identify a first mobile device of a first member of a household and identify a second mobile device of a second member of the household. The system may determine that the first member falls within a first demographic (e.g., is a male) and that the second member falls within a second demographic (e.g., is a female) based on their respective purchases. Promotion instructions 125 may determine a first set of promotions for the first member and a second set of promotions for the second member. The system may then provide the first set of promotions to the first mobile device of the first user and the second set of promotions for the second mobile device of the second user. Thus, even though the first user and the second user may use the same user identifying information for purchase transactions, the system may analyze and provide relevant information for each based on their respective purchase transactions, as determined from the presence or absence of their respective mobile devices. Alternatively or additionally, promotion instructions 125 may provide a targeted promotion for the household (or at least two members of the household) as a single unit and provide the targeted promotion to one or more of the mobile devices associated with the household.

Retail Establishments

In an implementation, a retail establishment 150 may include or otherwise be associated with in-store computer system 152 and point of sale (“POS”) computer system 154. Retail establishment 150 may agree to provide the purchase information to computer system 110. For example, POS computer system 154 may process transactions at retail establishment 150 and may provide purchase information related to the transactions directly to computer system 110 and/or to in-store computer system 152, which provides the purchase information to computer system 110.

In an implementation, some or all of the instructions described herein with respect to correlation application 120 may be included with or otherwise program in-store server 152 and/or POS computer system 154 to locally perform some or all of the functions of computer system 110. In this implementation, retail establishment 150 may identify mobile devices 170 of its customers. In other implementations, computer system 110 may identify mobile devices 170 and provide such identifications to retail establishment 150 (through in-store server 152 and/or point of sale computer system 154).

Location Services and Mobile Devices

In an implementation, location service 160 may include a system that obtains and provides locations of mobile devices 170. For example, location service 160 may include wireless operators, social networking sites that allow users to register their locations, and/or other entities that obtain a location of a mobile device and a time at which the mobile device was at the location.

In an implementation, mobile device 170 may include generally portable computer devices that can be located. For example, mobile device 170 may include, without limitation, a smartphone, a cellular phone, a tablet computer, and/or other devices that can be located. A user of the mobile device 170 may consent to having location information provided in order to receive relevant information. In an implementation, mobile device 170 may provide at least some of the location information to location service 160, which communicates the location information to computer system 110. In an implementation, mobile device 170 may provide the location information directly to computer system 110.

Although illustrated in FIG. 1 as a single component, computer system 110 may include a plurality of individual components (e.g., computer devices) each programmed with at least some of the instructions of correlation application 120. In this manner, some components of computer system 110 may perform some functions of correlation application 120 while other components may perform other functions of correlation application 120, as would be appreciated. The one or more processors 112 may include one or more physical processors that are programmed by computer program instructions. The various instructions described herein are exemplary only. Other configurations and numbers of instructions may be used, so long as the processor(s) 112 are programmed to perform the functions described herein. Furthermore, it should be appreciated that although the various instructions are illustrated in FIG. 1 as being co-located within a single processing unit, in implementations in which processor(s) 112 includes multiple processing units, one or more instructions may be executed remotely from the other instructions.

The description of the functionality provided by the different instructions described herein is for illustrative purposes, and should not intended be viewed limiting, as any of the instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the instructions.

The various instructions described herein may be stored in a storage device 114, which may comprise random access memory (RAM), read only memory (ROM), and/or other memory. The storage device may store the computer program instructions (e.g., the aforementioned instructions) to be executed by processor 112 as well as data that may be manipulated by processor 112. The storage device may comprise floppy disks, hard disks, optical disks, tapes, or other storage media for storing computer-executable instructions and/or data.

The various components illustrated in FIG. 1 may be coupled to at least one other component via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1 and other drawing figures, different numbers of entities than depicted may be used. Furthermore, according to various implementations, the components described herein may be implemented in hardware and/or software that configure hardware.

The various databases 160 described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

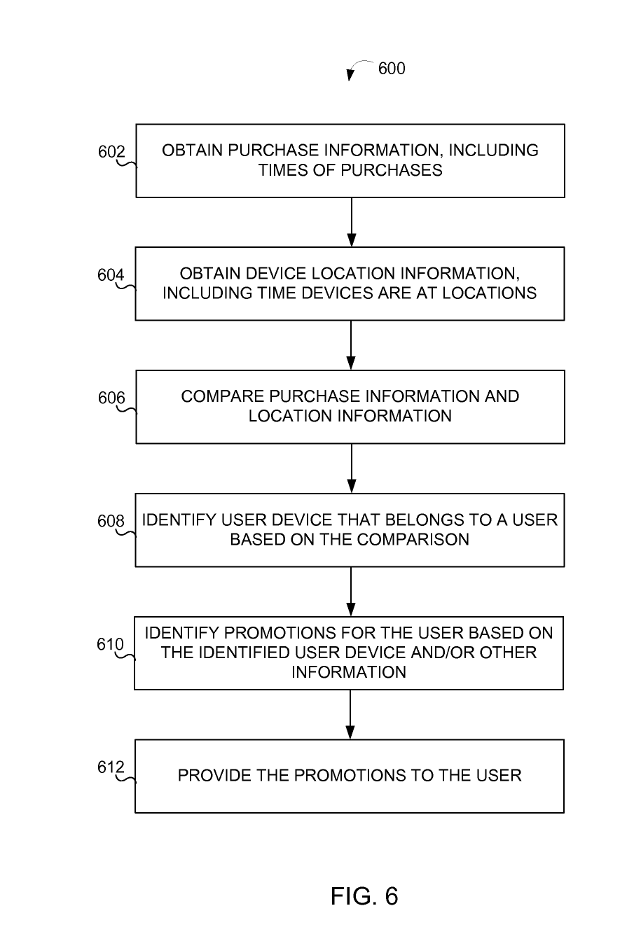

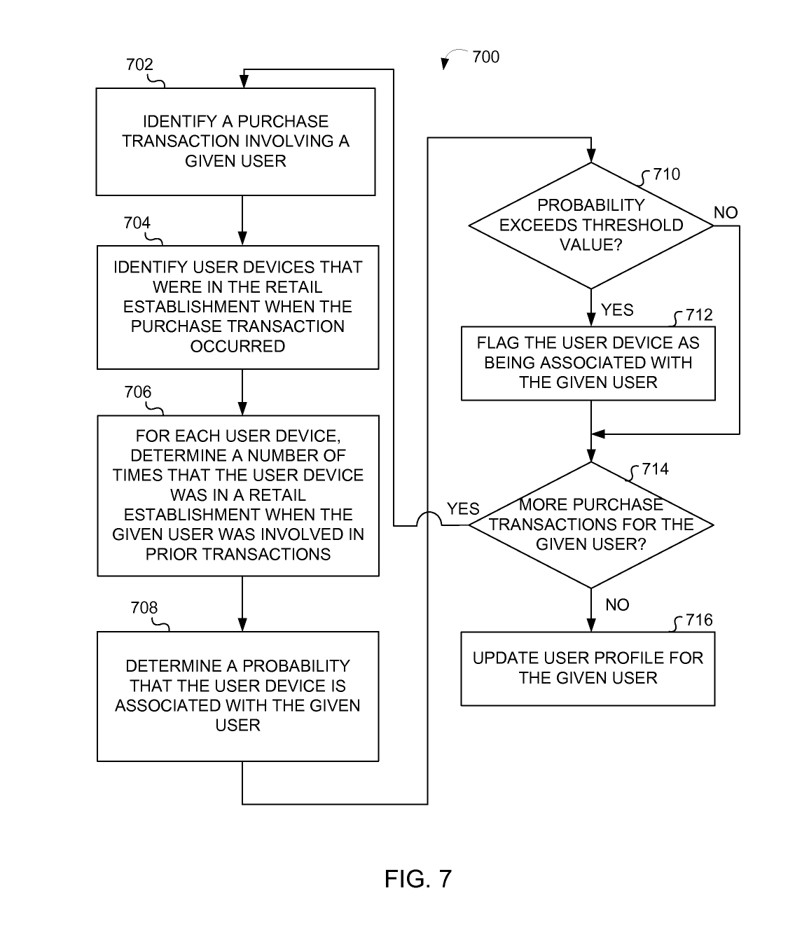

FIG. 6 illustrates a flow diagram of an exemplary process 600 of identifying mobile devices of users involved in purchase transactions, according to an implementation of the invention. The various processing operations and/or data flows depicted in FIG. 6 (and in the other drawing figures, including FIG. 7) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 602, purchase information may be obtained. The purchase information may include information related to one or more purchase transactions made at one or more retail establishments. Each purchase transaction may relate to a particular user and may include user identification information that identifies the user involved in the purchase transaction. Furthermore, each purchase transaction may include a time when the purchase occurred and retailer identification information that identifies retail establishment. The purchase information may also include purchase transaction details such as, without limitation, a price paid for an item, a quantity or volume of the item that was purchased, an incentive or discount price applied, and/or other purchase transaction information.

In an operation 604, location information may be obtained. The location information may include locations of one or more mobile devices and the times at which the mobile devices were at the locations. The location information may include periodic location assessments over time of a given mobile device. In this manner, the location of a given mobile device may be determined at a given time, even though a location record for the mobile device is not available for the given time. For example, the location information may include a first record that indicates a first location of a mobile device at a first time and a second location of the mobile device at a second time. If the first location and the second location are determined to be the same location (e.g., within a configurable deviation), then the mobile device may be determined to be at that location between the first time and the second time. In an implementation, the location information may include a type of mobile device (e.g., a make, model, operating system, etc.), a type of location assessment used to determine the location (e.g., GPS, cell tower triangulation, social media check-ins, etc.), confidence information associated with the location assessment, and/or other information.

In an operation 606, the purchase information and the location information may be compared. For example, the time and location where a given transaction occurred may be compared to a location of a given mobile device and a time that the mobile device was at the location.

In an operation 608, a mobile device that is potentially associated with (e.g., belongs to, operated by, etc.) a user that was involved in a given transaction may be identified. For example, a mobile device that was at the location and time that a purchase transaction involving a given user occurred may be identified as potentially being associated with the given user.

In an operation 610, a promotion that may be relevant to the user may be identified. The promotion may be identified based on the identified mobile device that is associated with the user and/or other information known about the user.

In an operation 612, the promotion may be provided to the user through one or more communication channels, such as, without limitation, the identified mobile device, electronic mail, SMS text message, in-store display or printer, and/or other communication channels.

FIG. 7 illustrates a flow diagram of an exemplary process 700 of iteratively updating a probability that a mobile device is associated with a user involved in purchase transactions, according to an implementation of the invention. The various processing operations and/or data flows depicted in FIG. 7 (and in the other drawing figures, including FIG. 6) are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 702, a purchase transaction involving a given user may be identified. For example, the purchase information may be filtered or otherwise grouped by user identification information described herein. Such filtering/grouping may be performed programmatically and/or through queries to a database where the purchase information may be stored.

In an operation 704, mobile devices that were at the retail establishment when the purchase transaction occurred may be identified.

In an operation 706, for each identified mobile device, a number of times that the mobile device was at a retail establishment when the given user was involved in prior transactions may be determined.

In an operation 708, for each mobile device, a probability that the mobile device is associated with the given user may be determined. The probability may be based on the number of times that the mobile device was at a retail establishment when the given user was involved in prior transactions, the number of mobile devices there were at the retail establishment during the current transaction, the type of location assessment, confidence information associated with the location assessment, and/or other information.

In an operation 710, a determination of whether the probability for a given mobile device exceeds a threshold value may be made. If the probability exceeds the threshold value, then the mobile device may be flagged as being associated with the given user in an operation 712. Such flagging may trigger certain actions to be taken. For example, promotions that are potentially relevant for the user associated with the mobile device may be delivered to the mobile device based on the flagging. Other actions, such as identifying relevant promotions for the user based on the mobile device may be based on the flagging. In an implementation, even if not flagged as being associated with a user (e.g., even if the probability does not exceed the threshold value), the probability that a given mobile device belongs to a user may be used to determine whether to use the given mobile device as a communication channel to deliver promotions, identify relevant promotions, and/or take other actions.

In an operation 714, a determination of whether more purchase transactions for the given user is available may be made. If more purchases transactions are available, processing may return to operation 702. On the other hand, if no more purchase transactions are available, processing may proceed to an operation 716. In operation 716, a user profile may be updated with the probability that a given mobile device is associated with the user and/or the flag that the mobile device is associated with the user. Each user profile may include more than one mobile device that is potentially associated with the user and each of those devices may be associated with a respective probability.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

1. A computer implemented method of identifying mobile devices of users based on purchases made by the users at retail establishments, the method being implemented by a computer system having one or more physical processors programmed with computer program instructions that, when executed by the one or more physical processors, cause the computer system to perform the method, the method comprising:
obtaining, by the computer system, purchase information associated with a plurality of purchase transactions made at one or more retail establishments, including at least a first purchase transaction, wherein the purchase information includes at least a time of the first purchase transaction, retailer identification information that is used to identify a retail establishment at which the first purchase transaction was made, and user identification information used to identify the user involved in the first purchase transaction;
obtaining, by the computer system, location information related to a plurality of mobile devices, including at least a first mobile device, wherein the location information includes mobile device identification information associated with the first mobile device, a location of the first mobile device, and a time that the first mobile device was at the location;
identifying, by the computer system, for at least the first purchase transaction: (i) an area associated with a first retail establishment at which the first purchase transaction was made based on the purchase information, (ii) a set of mobile devices, including the first mobile device, that were in the area at the time of the first purchase transaction based on the location information, and (iii) first user identification information that identifies a first user involved in the first purchase transaction based on the purchase information;
comparing, by the computer system, the time of the first purchase transaction from the purchase information with the time that the first mobile device was at the location; and
determining, by the computer system, a first probability that the first user involved in the first purchase transaction is a user of the first mobile device that was in the area at the time of the first purchase transaction, based on the comparison.

2. The method of claim 1, wherein the plurality of purchase transactions comprise a second purchase transaction at a second time involving the first user at the retail establishment, the method further comprising:
determining whether the first mobile device was in the area at the second time; and
updating the first probability responsive to the determination of whether the first mobile device was in the area at the second time.

3. The method of claim 2, wherein updating the first probability comprises increasing the first probability responsive to a determination that the first mobile device was in the area at the second time.

4. The method of claim 2, wherein updating the first probability comprises decreasing the first probability responsive to a determination that the first mobile device was not in the area at the second time.

5. The method of claim 1, wherein the plurality of purchase transactions comprise a second purchase transaction at a second time involving the first user at a second retail establishment, the method further comprising:
determining a second area associated with the second retail establishment at which the second purchase transaction was made based on the purchase information;
determining whether the first mobile device was in the second area at the second time; and
updating the first probability responsive to the determination of whether the first mobile device was in the second area at the second time.

6. The method of claim 5, wherein updating the first probability comprises increasing the first probability responsive to a determination that the first mobile device was in the second area at the second time.

7. The method of claim 5, wherein updating the first probability comprises decreasing the first probability responsive to a determination that the first mobile device was not in the second area at the second time.

8. The method of claim 1, the method further comprising:
determining whether the first probability exceeds a threshold value; and
determining that the first user is the user of the first mobile device responsive to a determination that the first probability exceeds the threshold value.

9. The method of claim 1, wherein determining the first probability comprises:
determining a number of the set of mobile devices that were in the area at the time of the first purchase transaction, wherein the first probability is based on the number.

10. The method of claim 1, the method further comprising:
identifying one or more promotions to provide to the first user; and
providing the one or more promotions to the first user.

11. The method of claim 10, the method further comprising:
determining a type of the first mobile device, wherein identifying the one or more promotions is based on the type of the first mobile device.

12. The method of claim 10, wherein the one or more promotions are identified based on the first purchase transaction and/or a purchase history of the first user.

13. The method of claim 10, the method further comprising:
classifying the first user into a user segment based on the probability that the first user involved in the first purchase transaction is the user of the first mobile device that was in the area at the time of the first purchase transaction, wherein the user segment includes a set of users that share at least one common characteristic with one another, wherein the one or more promotions are identified based on the user segment.

14. The method of claim 1, wherein the mobile device identification information comprises unique identification information used to identify a corresponding mobile device, a corresponding user account, and/or a corresponding user of the mobile device.

15. A system of identifying mobile devices of users based on purchases made by the users at retail establishments, the system comprising:
a computer system having one or more physical processors programmed with computer program instructions that, when executed by the one or more physical processors, cause the computer system to:
obtain purchase information associated with a plurality of purchase transactions made at one or more retail establishments, including at least a first purchase transaction, wherein the purchase information includes at least a time of the first purchase transaction, retailer identification information that is used to identify a retail establishment at which the first purchase transaction was made, and user identification information used to identify the user involved in the first purchase transaction;
obtain location information related to a plurality of mobile devices, including at least a first mobile device, wherein the location information includes mobile device identification information associated with the first mobile device, a location of the first mobile device, and a time that the first mobile device was at the location;
identify, for at least the first purchase transaction: (i) an area associated with a first retail establishment at which the first purchase transaction was made based on the purchase information, (ii) a set of mobile devices, including the first mobile device, that were in the area at the time of the first purchase transaction based on the location information, and (iii) first user identification information that identifies a first user involved in the first purchase transaction based on the purchase information;
compare the time of the first purchase transaction from the purchase information with the time that the first mobile device was at the location; and
determine a first probability that the first user involved in the first purchase transaction is a user of the first mobile device that was in the area at the time of the first purchase transaction, based on the comparison.

16. The system of claim 15, wherein the plurality of purchase transactions comprise a second purchase transaction at a second time involving the first user at the retail establishment, wherein the computer system is further programmed to:
determine whether the first mobile device was in the area at the second time; and
update the first probability responsive to the determination of whether the first mobile device was in the area at the second time.

17. The system of claim 16, wherein, to update the first probability, the computer system is further programmed to:
increase the first probability responsive to a determination that the first mobile device was in the area at the second time.

18. The system of claim 16, wherein, to update the first probability, the computer system is further programmed to:
decrease the first probability responsive to a determination that the first mobile device was not in the area at the second time.

19. The system of claim 15, wherein the plurality of purchase transactions comprise a second purchase transaction at a second time involving the first user at a second retail establishment, wherein the computer system is further programmed to:
determine a second area associated with the second retail establishment at which the second purchase transaction was made based on the purchase information;
determine whether the first mobile device was in the second area at the second time; and
update the first probability responsive to the determination of whether the first mobile device was in the second area at the second time.

20. The system of claim 19, wherein, to update the first probability, the computer system is further programmed to:
increase the first probability responsive to a determination that the first mobile device was in the second area at the second time.

21. The system of claim 19, wherein, to update the first probability, the computer system is further programmed to:
decrease the first probability responsive to a determination that the first mobile device was not in the second area at the second time.

22. The system of claim 15, wherein the computer system is further programmed to:
determine whether the first probability exceeds a threshold value; and
determine that the first user is the user of the first mobile device responsive to a determination that the first probability exceeds the threshold value.

23. The system of claim 15, wherein, to determine the first probability, the computer system is further programmed to:
determine a number of the set of mobile devices that were in the area at the time of the first purchase transaction, wherein the first probability is based on the number.

24. The system of claim 15, wherein the computer system is further programmed to:
identify one or more promotions to provide to the first user; and
provide the one or more promotions to the first user.

25. The system of claim 24, wherein the computer system is further programmed to:
determine a type of the first mobile device, wherein the one or more promotions are identified based on the type of the first mobile device.

26. The system of claim 24, wherein the one or more promotions are identified based on the first purchase transaction and/or a purchase history of the first user.

27. The system of claim 24, wherein the computer system is further programmed to:
classify the first user into a user segment based on the probability that the first user involved in the first purchase transaction is the user of the first mobile device that was in the area at the time of the first purchase transaction, wherein the user segment includes a set of users that share at least one common characteristic with one another, wherein the one or more promotions are identified based on the user segment.

28. The system of claim 15, wherein the mobile device identification information comprises unique identification information used to identify a corresponding mobile device, a corresponding user account, and/or a corresponding user of the mobile device.

29. The system of claim 15, wherein the computer system is further programmed to:
determine for at least the first purchase transaction a second probability that the first user involved in the first purchase transaction is a user of a second mobile device that was in the area at the time of the first purchase transaction.

30. The system of claim 15, wherein the user identification information is associated with a plurality of users, and wherein the computer system is further programmed to:
determine for at least the first purchase transaction a second probability that a second user involved in the first purchase transaction is a user of a second mobile device that was in the area at the time of the first purchase transaction.

31. The method of claim 1, wherein the location information comprises physical location information.

32. The system of claim 15, wherein the location information comprises physical location information.
